(19) United States
(12) Patent Application Publication
(10) Pub. No.: US 2022/0198504 A1
(43) Pub. Date: Jun. 23, 2022

(54) SYSTEM AND METHOD FOR LOYALTY PROGRAMS

(71) Applicants: Jeff LOGAN, Ridgewood, NJ (US); Robert IANNONE, Ridgewood, NJ (US)

(72) Inventors: Jeff LOGAN, Ridgewood, NJ (US); Robert IANNONE, Ridgewood, NJ (US)

(21) Appl. No.: 17/460,489

(22) Filed: Aug. 30, 2021

Related U.S. Application Data
(60) Provisional application No. 63/072,058, filed on Aug. 28, 2020.

(51) Int. Cl. G06Q 30/02

(52) U.S. Cl. CPC G06Q 30/0226

(57) ABSTRACT

A system and method for a flexible loyalty program in which points or rewards within that program are converted to shares within an associated company or other publicly traded companies.

### FIELD OF THE INVENTION

A system and method for allowing merchant loyalty program members to convert their reward points into shares of public companies and other publicly traded securities.

### BACKGROUND OF THE INVENTION

Products and services companies offer customers loyalty points in return for purchases with the intention of making these customers more loyal and incentivizing them to spend more with the merchant. Loyalty points take many forms from airline miles, to discounts, to special services and experiences to points that can be redeemed for merchandise.

Research shows that customers who are rewarded points are more loyal, and customers who redeem those points are even more loyal and motivated to continue spending more with the merchant.

One challenge for marketers and customers alike is points redemption. Many loyalty programs require cards, passcodes, QR codes and/or complicated processes that discourage redemption. The result is that over 13 trillion airline miles are currently outstanding and go un-redeemed. Most loyalty programs have similar situations where redemption processes discourage customer redemption.

Another challenge for marketers is that younger customers are increasingly dissatisfied with legacy redemption options for loyalty points. This is exacerbated when companies devalue points or change the terms, further dis-incentivizing customers from making the purchases necessary to acquire them.

A further challenge for marketers is that younger customers prefer to interact with and redeem from their loyalty programs via mobile devices. In addition, customers generally prefer multiple ways in which to interact with loyalty programs, which can be difficult to both promote and control.

### BRIEF SUMMARY OF THE INVENTION

The background art does not teach or suggest a flexible, multi-pronged loyalty program which offers multiple touchpoints and ways for the customer to interact with the program. The background art also does not teach or suggest such a program which supports both flexibility and control. The background art also does not teach or suggest a system and method for supporting such a program.

The present invention, in at least some embodiments, provides a system and method for a flexible loyalty program in which points or rewards within that program are converted to shares within an associated company.

By “associated company” it is meant either a company providing the loyalty program or with which the loyalty program is associated, or a partner company that does not directly provide the loyalty program but that offers transactions that are based on points or other rewards within that program, to enable an owner of such points to purchase shares within the partner company. The associated company may also be referred to as a “merchant” herein. Either term preferably relates to the loyalty/rewards program manager (i.e., brand manager). The Merchant can be consumer goods company managing their own loyalty program, or a third-party service provider that manages the loyalty program on behalf of the Merchant, among others such as credit card providers, financial institutions, airlines, car leasing and travel related companies.

By “share” it is meant any unit of ownership of a part of a company, including without limitation “fractional shares”. Less than one share of equity is called a fractional share. While fractional shares have value, they are typically difficult to sell through the stock market in a normal equity trade. Optionally, instead of or in addition to shares, the points may be exchanged for bonds.

The terms “points” and awards are used interchangeably herein.

The term “broker” refers to the role of a firm when it acts as an investment advisor, agent or fiduciary for a customer and charges the customer a commission for its services. This function may be performed by one or more entities. As used herein the term “broker” also refers to a computer system operated by such a firm, for the purpose of supporting trades, which may also support compliance and other trade related functions.

The term “loyalty program”, or “rewards program”, relates to a program that encourages shoppers to return to stores or merchants where they frequently make purchases. Some of the incentives may include point rewards to the purchase of merchandise or services, advanced access to new products, or additional discounts.

The term customer or member—refers to the individual consumer (i.e., Loyalty Program Members) that participate in the Merchant Loyalty program or potential joiners. The term Customer and Member are used interchangeably throughout this document. The term “user”, as for example the user of a user interface, may also be used interchangeably with customer or member.

According to at least some embodiments, there is provided a system and method for supporting purchase of a share of an associated company by using points from a loyalty program. The system preferably comprises a user computational device for operating a user interface. The user interface may comprise a stand-alone software or may be integrated into the app of the company operating the loyalty program. For example and without limitation, airlines operate such loyalty programs, information about which is typically accessible through their own branded app. The user interface is configured to offer customers the opportunity to have their loyalty points swept into a brokerage account where they can be redeemed for equity shares in private companies on an automated basis.

For example, to support such a purchase, the user interface supports an interconnection between loyalty program information and a brokerage software module. A customer may be required to enter personal information to the user interface; if the interface is integrated into another app, the customer may be required to enter additional information, such as for example identifying details and/or credit card or other financial instrument information.

Optionally, the user interface pulls customer profile and credit information directly from the merchant's records and pre-fill the new account form to be verified by the customer. This information is then passed through a middleware system, for example for determining compliance and also for connecting to a company loyalty program software module to determine the number of points available to the customer. This information, preferably along with the order for share(s), is then passed to the brokerage software module for purchase of the order. The middleware system may levy transaction fees and other fees for facilitating this process.

The brokerage software module and/or the middleware system confirms that the customer is an eligible and suitable person/investor and clears the customer for participation in the stock-backed loyalty program by running OFAC checks and Customer Due Diligence (i.e., CDD, KYC, Know Your Customer) in the background.

Customers can specify how many of their loyalty points should be swept into the brokerage account and into which public companies the points should be invested. By default, if the merchant is a publicly traded company the first option is to buy the merchant's stock to best bolster the merchant's brand and to maintain the direct loyalty relationship between customer (i.e., rewards member) and merchant. The broker reports on all investment transactions and reports back to the middleware which in turn reports to the customer who views this information through the user interface. This communication is preferably managed by the middleware system which charges commensurate fees for doing so.

Optionally, the user interface comprises a core stock-ordering functionality for supporting connection to the middleware system, which is integrated with functionality for accessing the loyalty program information. Alternatively, these functions are separate. Also optionally, the user interface may comprise a wallet for supporting integration of transactions across a plurality of loyalty programs. Such a wallet may also be used for viewing the subsequent portfolio of stock purchases. The wallet may also optionally be used for viewing points available, cash-value, pending orders, and portfolio market value. The wallet may also be provided separately.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

A list of non-limiting, exemplary acronyms is provided in the table below.

| Acronyms | Term |
|---|---|
| ACATS | Automated Customer Account Transfer Service |
| ACH | Automated Clearing House |
| AML | Anti-Money Laundering |
| API | Application Program Interface |
| AWS | Amazon Web Services |
| CDD | Customer Due Diligence |
| CTX | Corporate Trade Exchange (Corporate) |
| CUSIP | Committee on Uniform Securities Identification Procedure |
| EDD | Enhanced Due Diligence |
| EIN | Employer Identification Number |
| ESG | Environmental, Social and Governance Investing |
| ETF | Electronically Traded Funds |
| FRD | Functional Requirements Document |
| IB | Introducing Broker |
| JSON | JavaScript Object Notation |
| KYC | Know Your Customer |
| MVP | Minimum viable product |
| NAICS | North American Industry Classification System |
| OFAC | Office of Foreign Assets Control |
| REST | Representational State Transfer (RESTful) |
| RIA | Registered Investment Advisor |
| SIC | Standard Industrial Classification |
| SRI | Socially Responsible Investing |
| UX | User Experience |
| XML | Extensible Markup Language |

Unless otherwise defined, all technical and scientific terms used herein have the same meaning as commonly understood by one of ordinary skill in the art to which this invention belongs. The materials, methods, and examples provided herein are illustrative only and not intended to be limiting.

An algorithm as described herein may refer to any series of functions, steps, one or more methods or one or more processes, for example for performing data analysis.

Implementation of the apparatuses, devices, methods and systems of the present disclosure involve performing or completing certain selected tasks or steps manually, automatically, or a combination thereof. Specifically, several selected steps can be implemented by hardware or by software on an operating system, of a firmware, and/or a combination thereof. For example, as hardware, selected steps of at least some embodiments of the disclosure can be implemented as a chip or circuit (e.g., ASIC). As software, selected steps of at least some embodiments of the disclosure can be implemented as a number of software instructions being executed by a computer (e.g., a processor of the computer) using an operating system. In any case, selected steps of methods of at least some embodiments of the disclosure can be described as being performed by a processor, such as a computing platform for executing a plurality of instructions. The processor is configured to execute a predefined set of operations in response to receiving a corresponding instruction selected from a predefined native instruction set of codes.

Software (e.g., an application, computer instructions) which is configured to perform (or cause to be performed) certain functionality may also be referred to as a “module” for performing that functionality, and also may be referred to a “processor” for performing such functionality. Thus, processor, according to some embodiments, may be a hardware component, or, according to some embodiments, a software component.

Further to this end, in some embodiments: a processor may also be referred to as a module; in some embodiments, a processor may comprise one or more modules; in some embodiments, a module may comprise computer instructions—which can be a set of instructions, an application, software—which are operable on a computational device (e.g., a processor) to cause the computational device to conduct and/or achieve one or more specific functionality.

Some embodiments are described with regard to a “computer,” a “computer network,” and/or a “computer operational on a computer network.” It is noted that any device featuring a processor (which may be referred to as “data processor”; “pre-processor” may also be referred to as “processor”) and the ability to execute one or more instructions may be described as a computer, a computational device, and a processor (e.g., see above), including but not limited to a personal computer (PC), a server, a cellular telephone, an IP telephone, a smart phone, a PDA (personal digital assistant), a thin client, a mobile communication device, a smart watch, head mounted display or other wearable that is able to communicate externally, a virtual or cloud based processor, a pager, and/or a similar device. Two or more of such devices in communication with each other may be a “computer network.”

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the drawings:

FIG. 1 shows an exemplary mobile app and website menu, for acting as a general navigation point for the functions as described for example with regard to FIGS. 14 and 15;

FIG. 2 shows a non-limiting, exemplary flow through a merchant reward program webpage, for supporting stock transactions as described herein;

FIG. 3 shows a non-limiting, exemplary detailed flow for a first time user of the stock transaction service;

FIG. 4 shows a non-limiting, exemplary flow for populating member information so that the member may perform stock transactions as described herein;

FIG. 5 shows a non-limiting, exemplary flow for converting points to a source of value for stock transactions;

FIG. 6 shows a non-limiting, exemplary flow for determining a frequency of points conversion to a store of monetary flow;

FIG. 8 shows a non-limiting, exemplary flow for providing information to members about the various transactions available and their associated rules;

FIG. 9 shows a non-limiting, exemplary flow for a flexible choice of investments, for situations in which self-directed investments by members are permitted;

FIG. 10 shows a non-limiting, exemplary flow for a wallet for handling stock transactions;

FIG. 11 shows an exemplary, non-limiting flow for supporting an investment made as a single order;

FIG. 12 shows a non-limiting, exemplary flow for updating wallet information;

FIG. 13 shows a non-limiting exemplary flow for generating ACH and tracer files;

FIG. 14 shows an exemplary, non-limiting system for supporting share purchases with loyalty program points according to at least some embodiments of the present invention; and

FIG. 15 shows an exemplary, non-limiting system, according to an illustrative implementation, for supporting share purchases with loyalty program points according to at least some embodiments of the present invention.

### DESCRIPTION OF AT LEAST SOME EMBODIMENTS

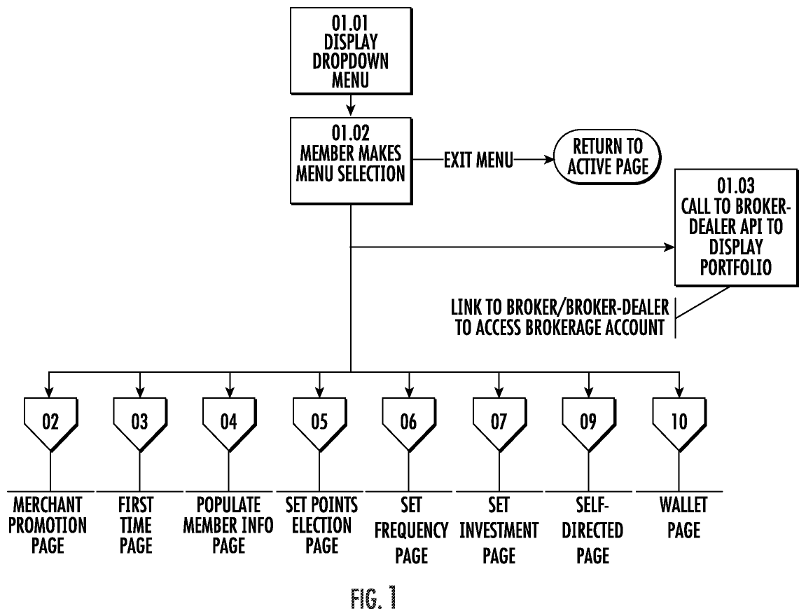

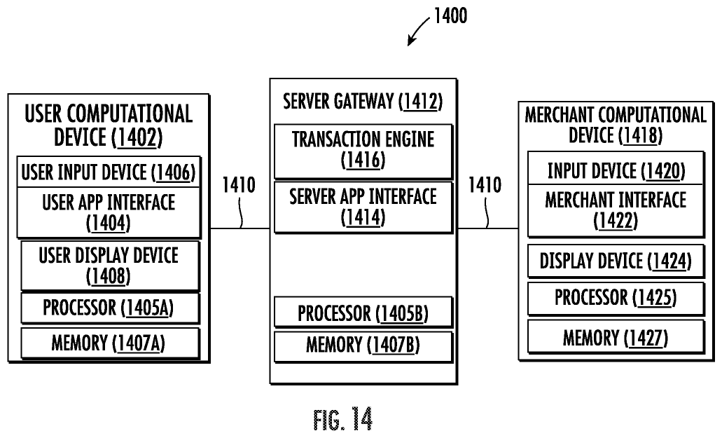

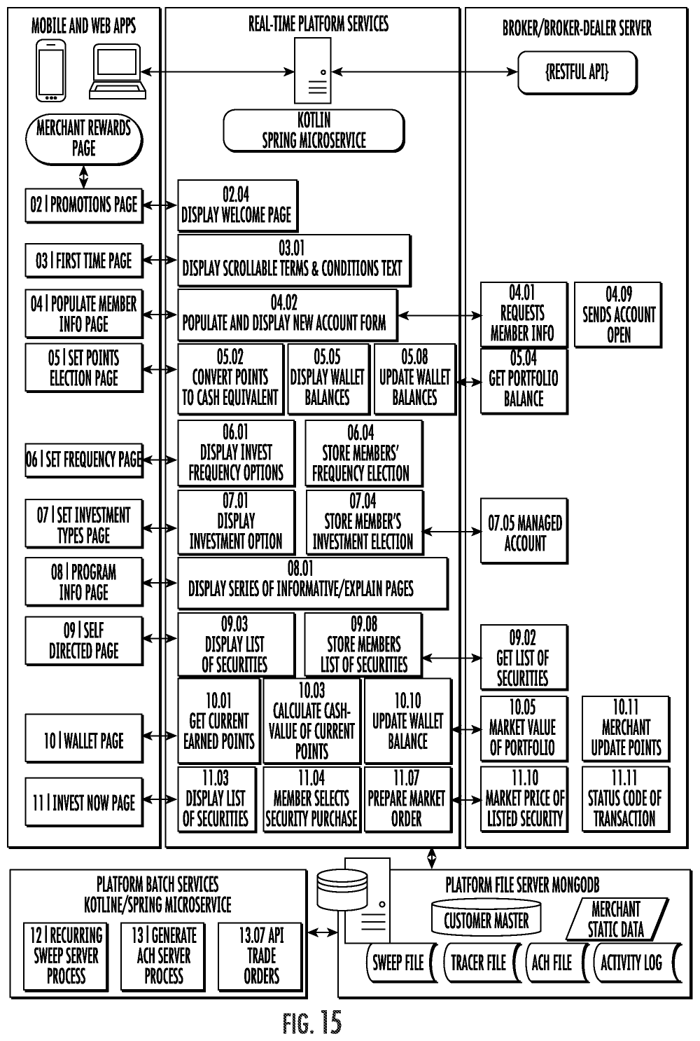

FIG. 1 shows an exemplary mobile app and website menu, for acting as a general navigation point for the functions as described for example with regard to FIGS. 14 and 15. As shown, a dropdown menu or other GUI widget 01.01 may be embedded within the Merchant's application and integrated with their menu options. Based on the unique options for individual Merchants these menu items may be altered to fit the combination of features offered by the Merchant and the wallet as described herein. The user makes a menu selection at 01.02, for example to start a transaction with a broker. For such a transaction a call is made to the corresponding broker API at 01.03. Other non-limiting menu options include a merchant promotion page 02, a first time user page 03, a request to provide personal and/or financial information page 04, and others as shown herein.

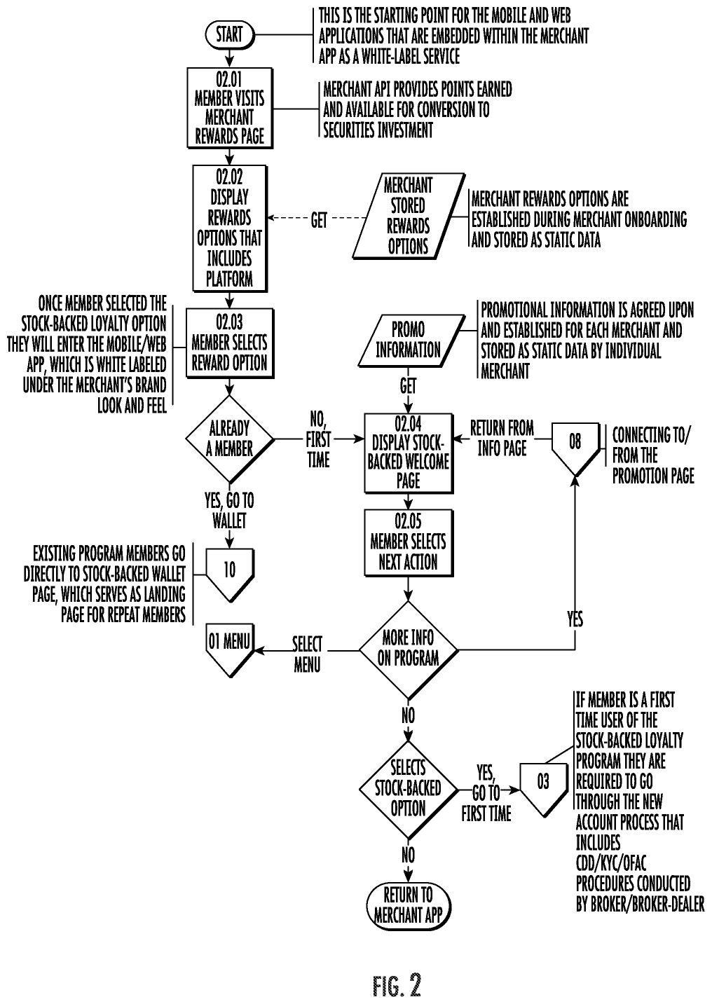

FIG. 2 shows a non-limiting, exemplary flow through a merchant reward program webpage, for supporting stock transactions as described herein.

The flow begins with step 02.01, when the Member Visits Merchant Rewards Page. Such a webpage may be provided as part of the user app interface as described with regard to FIGS. 14 and 15 for example. Such a rewards page may also have a stand-alone flow, within a larger set of functions for supporting the merchant's loyalty program, purchases by the member and other functions. The merchant provides Points Earned and available for conversion to securities investments, as well as any other information related to such transactions.

Next, at 02.02, the flow continues to a Display Rewards Option that includes stock transactions. This option is supported by a server-side module that manages the Merchant predefined options and overall program parameters, which in turn drives options made available to individual Members, along with the processing rules for trade orders and cash sweeps. The underlying information is stored in the system as described herein and is determined during the on-boarding process with the Merchant.

Once their Brokerage account is opened, Members have capabilities to manage their own account, including adding funds, liquidating funds, buying and selling securities, and ACATS entire account, etc.

At 02.03, the Member Selects Reward Option. Once the Member selects the stock-backed loyalty option, the functions may shift away from the merchant's server and into the separate stock transaction server, for example as shown with regard to FIG. 14. Preferably, the user interface maintains a similar brand look and feel. Existing Members go directly to Wallet Page, which serves as landing page for repeat Members.

At 02.04, the Display Welcome Page service-side application returns the details that make up the Merchant's stock-backed program based on predetermined parameters, such as the single-security option, stocks available based on Merchant's partnership program, the full list of securities, ETFs, mutual funds, and other financial investments. This page is preferably displayed the first time that a member wishes to perform a share transaction.

The information may include the maximum and minimum amounts that can be invested per investment cycle, and it will provide the frequency in trading cycles that the program follows. The offerings and promotions will also indicate program investment options, suggesting the types of investments a Member can make through the program, such as socially responsible investing (SRI), environmental, social and governance (ESG) investing, growth stocks, etc.

At 02.05, the Member Selects Next Action, to perform the new account process, which refers to opening an account both on Wallet program and passed through to open a brokerage account at the Broker, which may include Introducing Broker (IB) or Registered Investment Advisor (RIA), where applicable.

This process starts from the Merchant's mobile app or website from within the Merchant's loyalty program. It is invoked the first time a Member elects to join the stock-backed loyalty program. (i.e., new Customers).

The process flow checks the Customer Master database to determine if this is an existing customer with an open Brokerage account on record with the Broker. This process uses the information passed from the Merchant about the Customer using a system interface along with the Customer confirming their identity by providing through the user interface their tax ID (i.e. social security number) or other government issued ID which is used to lookup the existence of customer record.

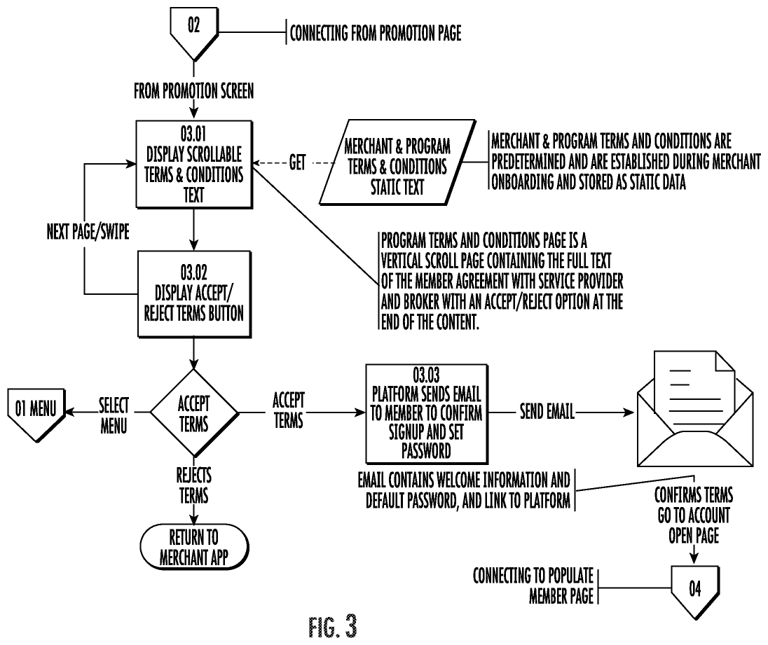

FIG. 3 shows a non-limiting, exemplary detailed flow for a first time user of the stock transaction service.

The flow preferably begins at 03.01, with the Display of Scrollable Terms & Conditions Text. Preferably the display relates to text of the Member agreement with the Broker with an accept/reject option at the end of the content.

This page will also provide a space for the Merchant to place information on their promotions and benefits of the stock-backed rewards program. These are flat text pages that operate within the Merchant's application containing the full text of the Member agreement with Broker with an accept/reject option at the end of the content.

The rewards membership must be established at Merchant first (e.g., Starbucks) then that program will give Member the option to use their points to buy securities. When the Member elects to use their points earned for the first time, they will be requested to open a Broker account and will go through KYC and OFAC compliance checks online using information sourced from the Merchant to prefill the new accounts form, where permissible.

Preferably, the flow continues at 03.02, with Display Accept/Reject Terms Button to allow the Member the option opt-in/out. The flow then preferably continues at 03.03, when the system sends email to member to confirm signup and optionally set account password. Email contains welcome information and default password, and link to the transaction site.

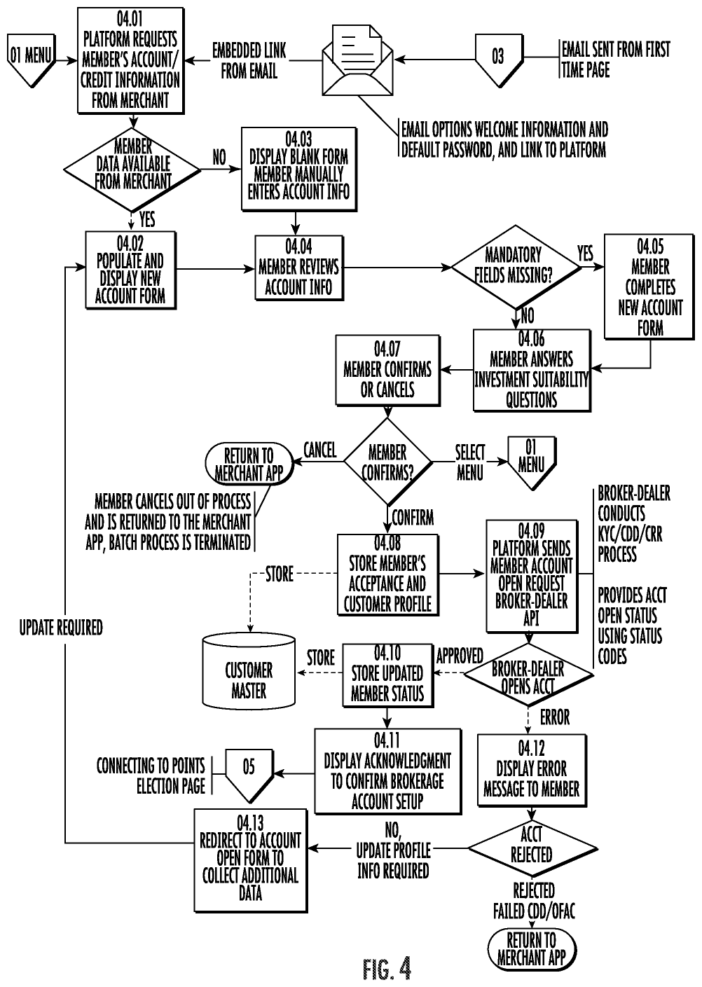

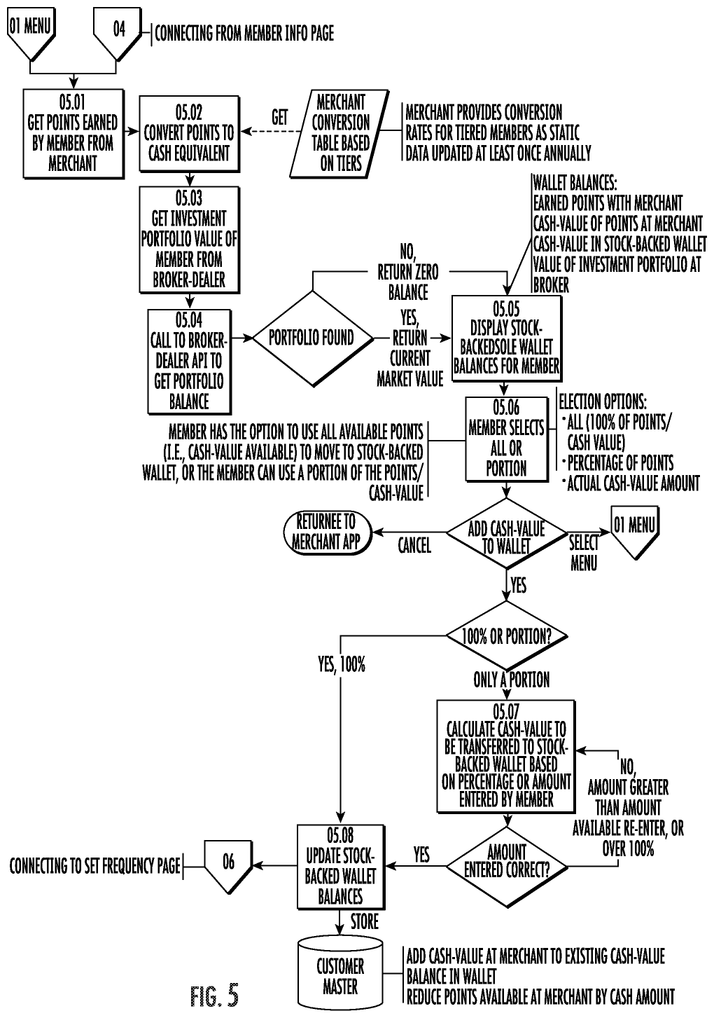

FIG. 4 shows a non-limiting, exemplary flow for populating member information so that the member may perform stock transactions as described herein.

The flow preferably begins at 04.01, in which First-time Members enter the process. For example, such members may enter this page via a link embedded in an email from Broker. Email contains welcome information and default password, and link to Broker site. The Broker Requests Member's Account/Credit Information from Merchant.

When a new account is opened, the Merchant will draw relevant Member information from their records to pre-fill the KYC/On-boarding online new account form which is to be passed through an API to the server application.

Any previously existing brokerage account held by the Member may not be connected to the Wallet or Brokerage Account setup by this process. The Broker in this scenario may have a unique relationship with the Member, who also maintains a relationship with the originating Merchant, as well as an account with the Broker.

Next, at 04.02, the flow continues to the Populate and Display New Account Form. This API pushes the Member profile through to the backend server-side application. It connects the frontend mobile and website account opening process to the backend KYC/OFAC on-boarding process.

At 04.03, Member Data Available from Merchant is displayed. Alternative a Blank Form is displayed and the Member Manually Enters Account Info. Next at 04.04, Member Reviews Account Info—If Mandatory fields are missing the Member will have to enter the required information.

At 04.05, the Member Completes New Account Form. At 04.06, the Member Answers Investment Suitability Questions—Members will have a separate brokerage account with independent credentials to access accounts; this information will be unknown to Merchant.

At this point the web or mobile app will require confirmation of the Member profile and suitability information by the Member. (Confirming pre-filled account opening form with the ability to update or add missing information.) At 04.07, the Member Confirms or Cancels—Upon confirmation the completed Member profile will be passed to the backend Broker/Broker-Dealer system for onboarding including KYC, OFAC and suitability questionnaire. If Member cancels out of process, they are returned to the Merchant app, and system process is terminated.

At 04.08, the Member's Acceptance and Profile are stored on the Customer Master.

At 04.09, Send Member Account Open Request Broker-Dealer API—Information collected from the Merchant records on a Member and confirmed by the Member will be used for both KYC and Anti-Money Laundering (AML) purposes as part of the Broker account opening process. This is a necessary compliance step to conduct a background check (i.e., CDD, Customer Due Diligence, OFAC and investment suitability check) to establish a trading account for the Customer. This process is facilitated through the platform's technical process flow via APIs connecting Merchant and Broker with the exchange of customer profile information. If the Customer passes the standard background check performed by the Broker they will receive a confirmation email from the Broker, If the background check processed by the Broker comes back negative/rejected, or requiring additional information, the Customer will receive an email from the Broker requesting additional information, which is conducted offline from this standard process while the customer will not be permitted to move forward with the account open process or the purchase of securities.

There are a few attributes that define the account, how and when it can trade, and who has trading authority.

At 04.10, the flow continues to Store Updated Member Status—After Broker-Dealer Opens Account, store the Member status on the Customer Master.

At 04.11, the flow continues to Display Acknowledgement to Confirm Brokerage Account Setup.

At 04.12, the Broker-Dealer returns an error code—Display Error Message to Member, if account setup is rejected return to merchant application. In such a case, the flow may continue at 04.13, in which Update Profile Info Required, redirect to New Account Open Form to Collect Additional Data.

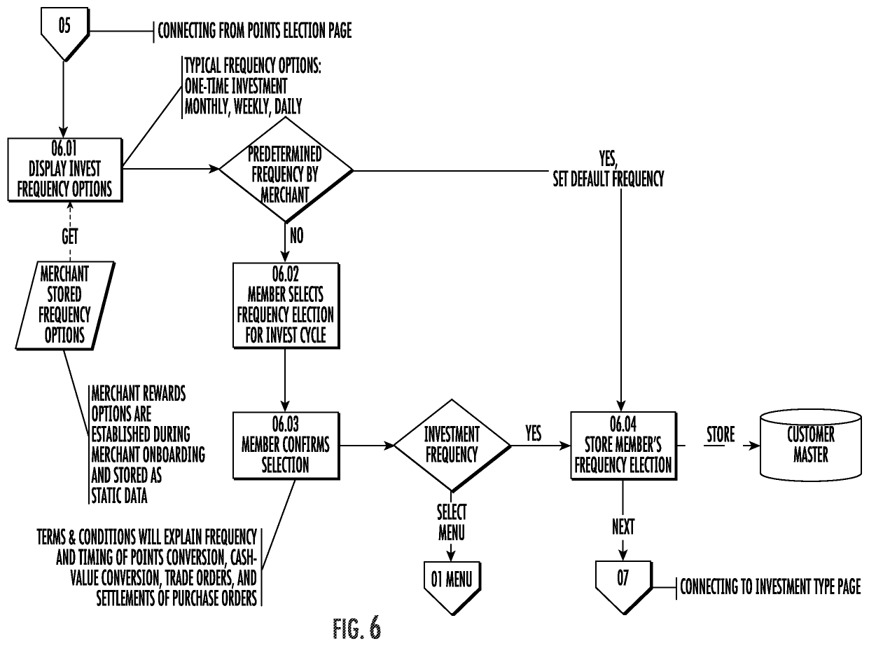

FIG. 5 shows a non-limiting, exemplary flow for converting points to a source of value for stock transactions. To begin, the number of points earned by the member is obtained from the merchant at 05.01. This process runs on the Merchant's platform to convert points earned by Members to cash-value equivalent. This page will show the total points earned through the Merchants rewards program, the Cash-value of those points. If the user interface is in a wallet format for a plurality of different merchants, this feature shows each Merchant-related balance and a summarized view of the balance across Merchants, and any pending amounts.

Merchants are responsible for providing the conversion rates based on the Member status within the rewards program. Typically, Merchants have a tiered structure based on the Member overall spend and tenure with the program.

Next, at 05.02, points are converted to Cash Equivalent. The conversion rate from points to cash value range from anywhere as low as 0.6 cents per point and up to two cents per point for a typical program. This will present points and investment options based on pre-established Merchant parameters that are stored on the platform. Merchant Conversion Table is based on Tiers, and the Merchant Provides Conversion Rates for Tiered Members, optionally as Static Data updated periodically. It will include available instruments along with max and min limits of points and dollars/cash values that can be used within the Merchant's rewards program. This information is stored on the platform and informs the elections page. Optionally conversion rates or exchanges may be considered with regard to the Merchant's rewards program with a relative surcharge and/or fixed fee applied to the calculation.

Merchants will be able to control how many points a Member can convert on a periodic and annualized basis. Once the Member makes their election it will be stored in the Wallet (Customer Master) and used later by the system to process Recurring Sweep/Bulk Order function to accumulate cash and place batch trade orders with Broker through Broker API.

It will allow Members to view two primary features of the program; 1) how many rewards-points they are allowed to use at any given time/cycle and on what frequency (i.e., one-time, weekly, monthly, quarterly, annually), and 2) what stocks/securities they are allowed to invest in based on conditions drawn from the Merchant Defined Options.

This will first occur during the initial account opening process; however, the Member can go back into the Set Points Election screen to adjust their election options later.

Next, at 05.03, the process of obtaining the Investment Portfolio Value of Member from Broker-Dealer is preferably started, more preferably before the member purchases any stock. For example, this process may feature, at 05.04, a call to Broker-Dealer API to Get Portfolio Balance.

Separately, at 05.05, the Wallet Balances for Member are displayed. On the convert points page display Wallet Balances: Earned Points with Merchant, Cash-value of Points at Merchant, Cash-value in Wallet, and Value of Investment Portfolio at Broker. Members will be given the option to elect a percentage of points to be used, or enter an exact amount based on their cash balance. If the portfolio is not found or does not exist at Broker, return Zero Balance. This page will show the total points earned through the Merchants rewards program, the Cash value of those points, and investment portfolio value for existing Members (e.g., Members with existing brokerage accounts associated to program).

The member indicates that they wish to start a transaction, by selecting all or a portion of points for the transaction at 05.06. From within the view page of the Wallet, Members will be able to commit a portion of their earned points to be converted to securities or have the option to convert the full amount. Member has the option to use all available points (i.e., Cash-value available) to move to Wallet, or the Member can use a portion of the points/cash-value. Election Options include for example: All (100% of Points/Cash-value), Percentage of Points, and Actual Cash-value Amount.

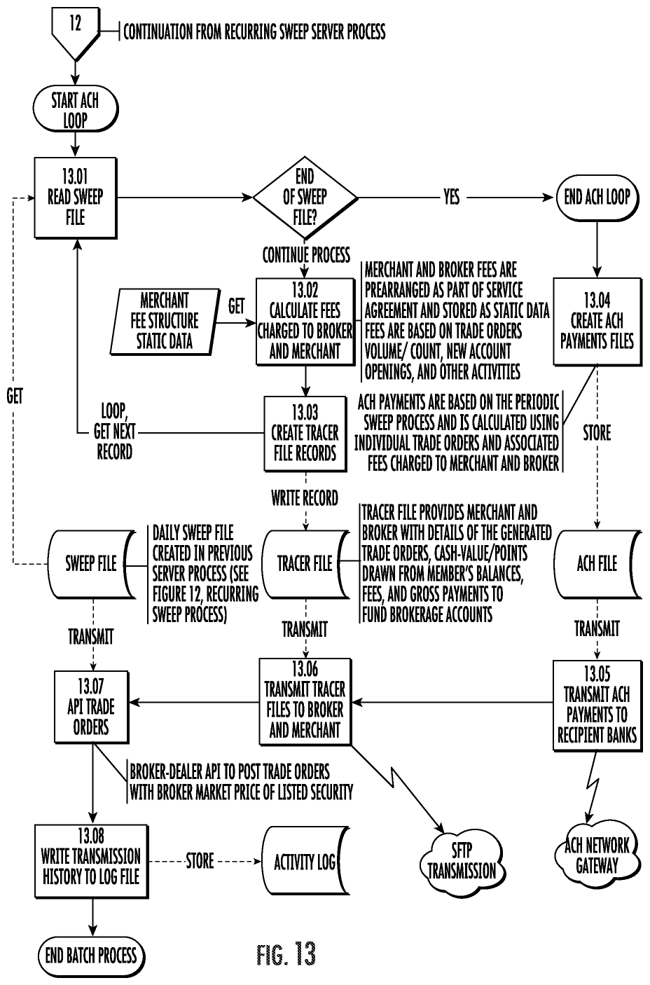

At 05.07, if the Member choices to use only a portion of the points cash-value, then calculate Cash-value to be transferred to Wallet based on percentage or amount entered by Member. The points will sit on the books of the Merchant until they are swept and converted into Trade Orders. Points are not actually converted to cash until the Trade Orders are generated. When the system process runs each periodic Sweep Process (i.e., bulk trade orders) the final conversion calculation is executed, the cash balance is accumulated to create a single ACH payment from Merchant to Broker. (See FIG. 13, Generate ACH Payments)

At 05.08, Wallet Balances are updated on the Customer Master, by adding Cash-Value to existing Cash-Value Balance in wallet and reduce Points Available by Cash Amount.

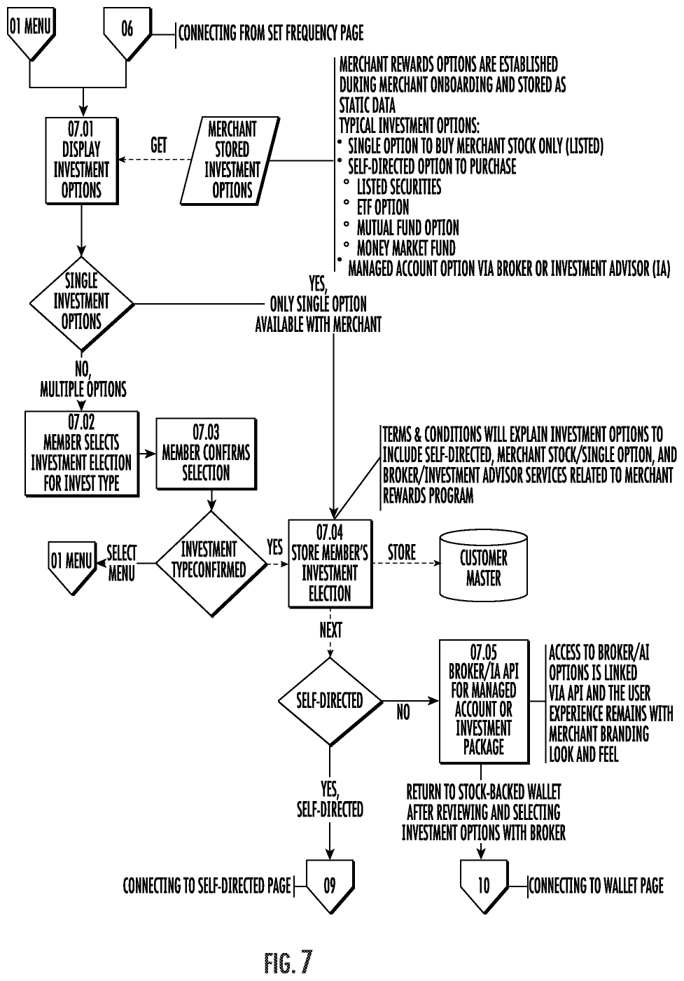

FIG. 6 shows a non-limiting, exemplary flow for determining a frequency of points conversion to a store of monetary flow.

The flows starts at 06.01, by displaying Invest Frequency Options—Typical Frequency Options: One-Time investment. or Monthly, Weekly, Daily, etc. The Merchant Frequency Options are obtained from merchant data. These options may be established during Merchant onboarding and stored as static data, or alternatively may be updated periodically. If Predetermined Frequency is provided by the Merchant, then the default frequency is set.

At 06.02, the member Selects Frequency Election for Invest Cycle. It will also allow the Member to select a one-time investment option, or elect for the reoccurring monthly or weekly sweep of their available cash balance to repeat investments based on selections made by the Member that are permissible through the Merchant loyalty program agreement. If the Member elects “one-time” investment option the recurring sweep process described in section 12 may bypass the Member. The one-time option indicates that the Member may only place trade orders on demand at any time as single non-recurring orders, which will be fulfilled by the Broker during normal market hours. Other options such as “monthly” may be implemented to establish a subscription membership to a recurring investment program that will be processed through the sweep process described in section 12.

At 06.03, the Member Confirms Selection, preferably by clicking to confirm their elections. At 06.04, the Member's Frequency Election on Customer Master is stored.

FIG. 7 shows a non-limiting, exemplary flow for determining an investment choice. Optionally the choice(s) is provided solely by the merchant, such that for example points may only be used for stocks associated with the merchant, or optionally also with a merchant partner. Alternatively, the merchant may provide a plurality of choices by category, such as for example large cap stocks, members of the Standard and Poor's 500, and so forth. Alternatively, the choice may be determined by the member according to any stock available through the broker.

The flow start at 07.01, by displaying Investment Options. Securities information will be sourced using the Broker Investments APIs to get available securities as defined by program along with current market values. Merchant Rewards Options are established during Merchant onboarding and stored as static data.

Typical Investment Options: Single Option to Buy Merchant stock only (Merchant must be a listed company); Self-Directed option to purchase Listed Securities, ETF Option, Mutual Fund Option, Money Market Fund; or Managed Account Option via Broker or Investment Advisor (IA).

The amount that can be used will be based on the thresholds established between Merchant and Broker, and within those parameters, will be set by each Member.

At 07.02, the Member Selects Investment Election for Invest Type. If a Single Investment Option is available through Merchant Program, store Member's Investment Election. Terms & Conditions will explain investment options to include Self-Directed, Merchant Stock/Single Option, and Broker/Investment Advisor services related to Merchant Rewards program.

Optionally at 07.03, the member must confirm selection or use menu to navigate. At 07.04, the Member's Investment Election is stored on Customer Master. A connection with broker/advisor may be made at 07.05. If Member selects Self-Directed options they will be redirected to Self-Direct Page; otherwise, the system process will access Broker/Investment Advisor (IA) for investment options using Broker/IA API for Managed Account or Investment Package. Access to Broker/IA options is linked via API and the user experience remains with Merchant branding look and feel. Return to Wallet after reviewing and selecting Investment Options with Broker.

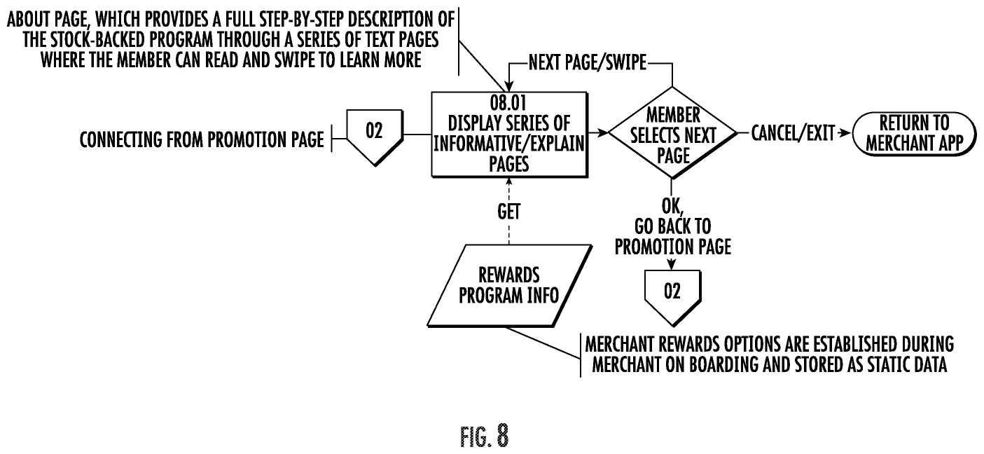

FIG. 8 shows a non-limiting, exemplary flow for providing information to members about the various transactions available and their associated rules.

The flow starts at 08.01 by displaying a Series of Informative/Explain Pages. This screen will allow Members to view a series of info pages that explain the stock-backed rewards program so that they can read relevant disclaimers and notices surrounding the program. The system will display rewards program info which is stored as static data. Merchant Rewards Options may be established during Merchant onboarding and stored as static data, or alternatively may be updated periodically.

The member would then continue through a plurality of different pages to show necessary information.

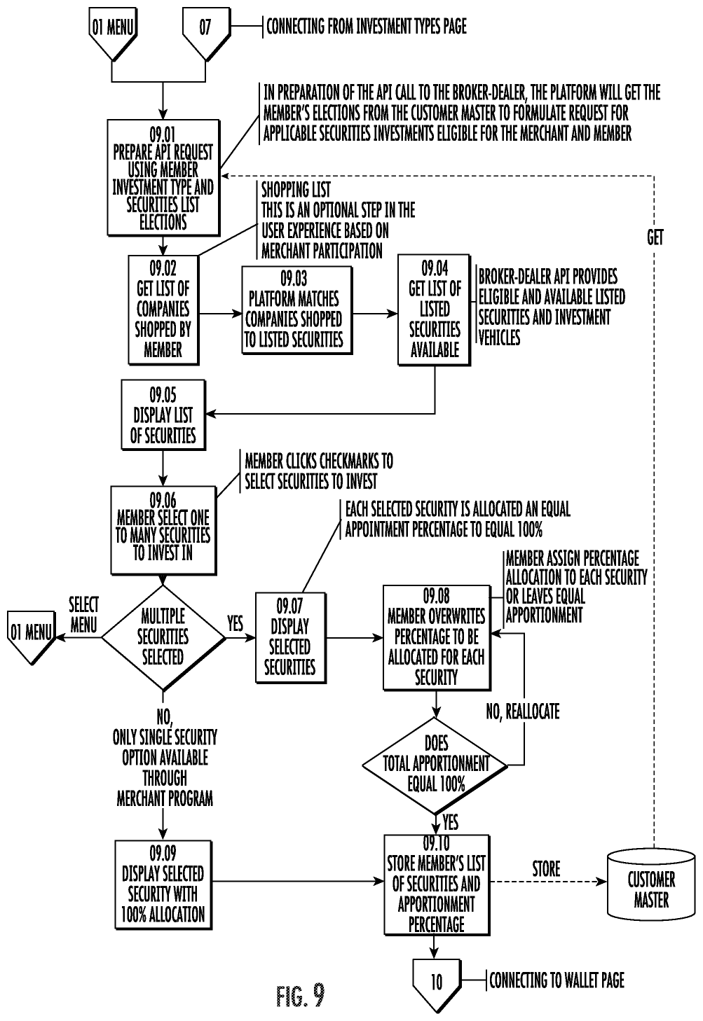

FIG. 9 shows a non-limiting, exemplary flow for a flexible choice of investments, for situations in which self-directed investments by members are permitted.

At 09.01, a request is made, using Member Investment Type and Securities List Elections. The request may be made as an API call to the broker. In preparation of the API Call to the Broker-Dealer, the system process will get the Member's elections from the Customer Master to formulate a request for applicable securities investments eligible for the Merchant and Member.

At 09.02, a list of Companies Shopped by Member is obtained, for example as a “Shopping Cart”, this is an optional step in the user experience based on Merchant participation in program. Merchant will provide information (i.e., list of recently used companies) on the Member's buying pattern to allow the Merchant to add to a shopping cart where the Member can then select from the list of brands/companies they use and enjoy to help drive loyalty.

At 09.03, the system matches Companies Shopped to Listed Securities, based on the list of companies names/IDs provided by Merchant on behalf of Member, the system will match against listed securities to create a Shopping Cart view to allow Members to select items for as potential trade order requests.

The list of available securities is then obtained at 09.04, Broker-Dealer API provides eligible and available Listed Securities and Investment Vehicles. Instruments are the investment products available to buy and sell on the platform. It will also source instrument and market data from the Broker-Dealer for presentation back to the Member. The Wallet will display available securities, market price, mark-to-market pricing of portfolio (may have a delay based on market data agreements).

The list of Securities is displayed at 09.04 by obtaining a Referential Quote on market price of securities. This will include combined list of Shopping Cart items, securities purchased in the past by Member, and other offerings based on Merchant stock-backed rewards program.

At 09.06, the member selects one or more securities to Invest In, for example by clicking checkmarks to select which securities to invest. Selected securities are displayed at 09.07, for example by listing multiple securities selected by Member. Each selected security is allocated an equal apportionment percentage to equal 100%. Optionally the member may overwrite the percentage at 09.08, by updating the percentage to be allocated for each Security. Member may elect to assign percentage allocation to each security or leave equal apportionment set by default.

At 09.09, the Selected Security is displayed, optionally with 100% Allocation. If only single security option available through Merchant Program then display selected security with 100% allocation. At 09.10, the member's List of Securities and Apportionment Percentage is updated on the Customer Master.

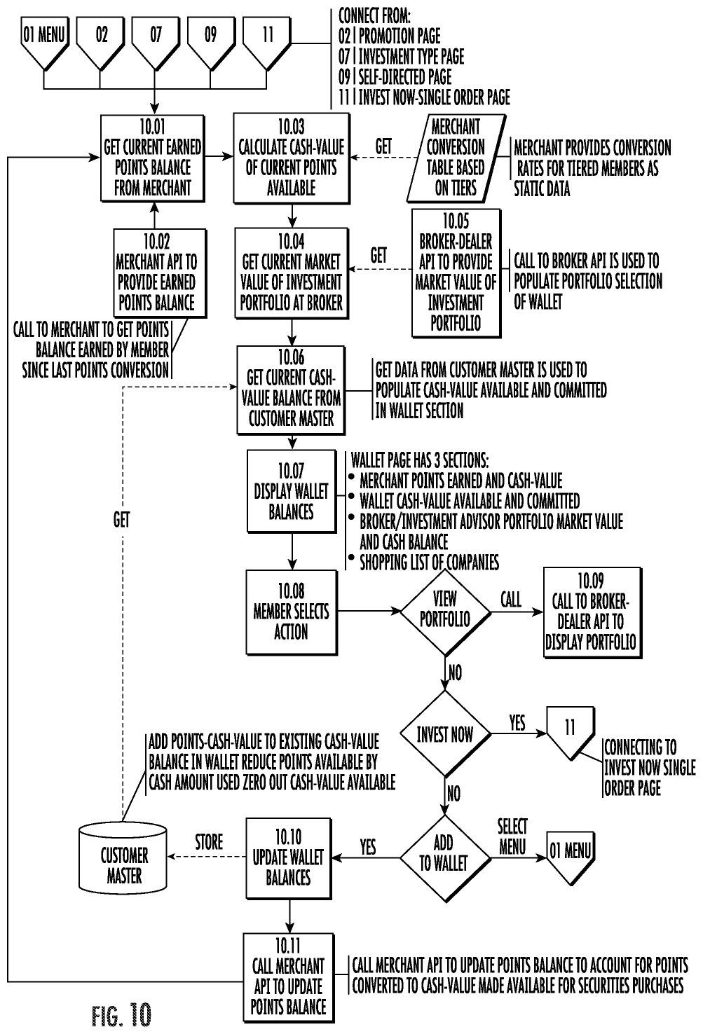

FIG. 10 shows a non-limiting, exemplary flow for a wallet for handling stock transactions.

The flow begins at 10.01, the Current Earned Points Balance is obtained from the Merchant, to support showing the points held, cash available, and portfolio balance information associated with the wallet. A member can connect to this primary page from various pages, including the dropdown menu: Promotion Page, Investment Type Page, Self-Directed Page, Invest Now-Single Order Page, etc.

This core module maintains the Wallet, which includes total points and cash-value of points held by each Member at Merchant, available cash-value in the Wallet to be used for securities purchases, portfolio merk-to-market values, and maintains pending orders, and the status of all transactions. The Wallet also contains the overall Member profile, standing elections and preferences, which are stored on the platform.

At 10.02, a call is made to the Merchant API to provide Earned Points Balance, which is the Points Balance earned by Member since last points conversion. This conversion occurs when the trade order is placed, and the cash hits the Brokerage account. The Cash-Value Balance shown on the Merchant's app is the pending conversion value, not actual cash.

At 10.03, the Cash-Value of Current Points Available is calculated. This information is to be sourced from the Customer Master database and combined with information sourced from the Broker portfolio for a given Member account. Optionally the cash-value is limited by the merchant according to the type of transaction selected, such that a plurality of different cash-values may be calculated and/or displayed. The Merchant Conversion Table may be based on Tiers, which is Merchant Provides Conversion Rates for Tiered Members. The points reflect the actual points earned by the Member through the Merchant's rewards program, while the cash is the conversion-value based on the rate established by the Merchant. For instance, if a Member has 25,000 points, they will have the cash equivalent of $150 based on a conversion rate set by the Merchant of 0.006 ( 6/10 of a cent per point).

The Wallet preferably only shows related activity. For full brokerage services related to the corresponding brokerage account, Members will use their relationship/account with the Broker to maintain the full portfolio. Alternatively, the wallet is integrated with a broker app, in which case it may show portfolio information associated with that broker.

The cash-equivalent value is preferably used to place Trade Orders only. To liquidate holdings into cash, the Member/Brokerage Client may be required to access their brokerage account at the Broker to Sell shares or ACAT their positions.

At 10.04, the Current Market Value of Investment Portfolio at the Broker is obtained. It also contains the overall brokerage portfolio value to be presented to the Member on request. This request will be processed through the Broker-Dealer market data API.

Preferably, at 10.05, the Broker-Dealer API provides Market Value of Investment Portfolio, through a call to Broker-Dealer API is used to populate Portfolio Section of Wallet. At 10.06, the Current Cash-Value Balance is obtained and used to populate Cash-Value available and committed in Wallet Section.

At 10.07, Wallet Balances are displayed. This view displays two balances, one for the pending stock order, and a second one for the stock they own. The Wallet shows the pending transactions as well as points already earned by Member along with their Stock Portfolio sitting at Broker. Included in the data being presented in the wallet are the pending transactions with the original status dates and target dates of trade execution, the real-time value of the portfolio based on market data provided by the Broker.

Optionally the cash balance sits in the Member's/Client's Brokerage account at the Broker on Broker platform. Wallet Page has 3 Sections:

1) Merchant Points Earned/Cash-Value,

2) Wallet Cash-value available and committed, and

3) Broker/Investment Advisor Portfolio Market Value.

That cash balance is typically the result of one of three things:

1) Funds transferred from Merchant and allocated to individual Members which sits in their account pending the purchase and settlement of the trade orders generated by the system,

2) Proceeds from the sale of stock/securities made by the Member through their brokerage account after settlement, again sitting at the Broker/Broker-Dealer, and

3) Funds sourced and provided directly by the Member into their own brokerage account, sitting at the Broker.

At 10.08, the member Selects Action: if Member select Invest Now option, they will be connected to Invest Now Single Order Page.

At 10.09, a call is made to Broker-Dealer API to Display Portfolio. This page will permit Members to view their brokerage accounts through the Merchant's frontend rewards application. It will use standard APIs provided by the Broker-Dealer to receive JSON files to be presented with the Merchant's application framework, using the Merchant's look-and-feel (i.e., style guides). A full view of the Brokerage Account is provided by Broker via APIs. This page will allow Members to access the full capacity of the Broker platform to manage their individual portfolios including the ability to buy and sell securities, and to move assets in and out of the brokerage account.

Some brokerage-related features will be available only on the Broker platform through APIs where the Member/Brokerage Client will have a direct relationship with the Broker with functions to correct and cancel orders. These will result in potentially sending additional instructions/transactions to Broker to properly modify/cancel trades with the appropriate audit trail.

Other Brokerage-related features may include but are not limited to deposits which allow clients to make a request to deposit money into their Broker account outside of the program; redemptions to allow clients to make a request to withdrawal money from their Broker account outside of the program. The ACAT system can be used to transfer client assets between a non-Broker brokerage account, and a Broker brokerage account. While incoming ACATs can be submitted via API, outgoing ACATs must be submitted directly by the Member to the receiving broker outside of the program. This API will present detailed statement information on request from the view portfolio function on the Merchant's mobile app or website application.

Another feature provided may include positions for every Account, whether securities or liquid cash, are generally provided over our APIs with real-time accuracy. Also optionally intraday pricing on positions (may have a delay based on market data agreements), as well as end of day/closing prices are provided from a broker for example, which will be used on statements.

The statements contain Member activity that, pursuant to regulatory requirements, will need to be furnished to Members vis Broker-Dealer.

At 10.10, the Wallet Balances are updated. If Members chooses to add to Wallet, the Wallet Balances will be updated on the Customer Master where Points-Cash-Value will be added to existing Cash-Value Balance in Wallet, reduce Points Available by Cash Amount Used, and zero-out Cash-Value Available.

At 10.11, the Merchant API is called to Update Points Balance, to account for Points converted to Cash-Value made available for securities purchases.

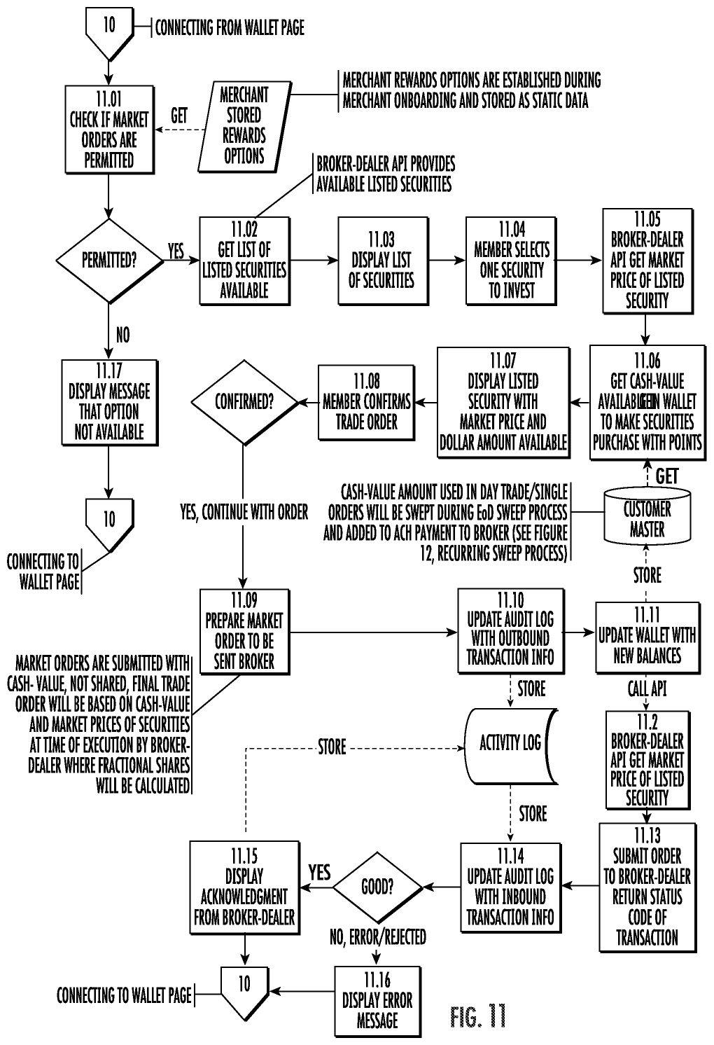

FIG. 11 shows an exemplary, non-limiting flow for supporting an investment made as a single order.

At 11.01, the flow checks whether Market Orders are Permitted, for example according to rewards options set by the merchant. Merchant Rewards Options may be established during Merchant Onboarding and Stored as Static Data. Alternatively, the merchant may choose to provide dynamic adjustment, for example through periodic adjustments. However such adjustments may be secured in a separate process which feeds into the flow but which is not performed as part of the flow.

At 11.02, the List of Listed Securities Available is obtained, using Broker-Dealer API which provides Available Listed Securities. At 11.03, the list of Securities is displayed. At 11.04, the member may select one Security to Invest. In this scenario the Member may only be permitted to make a single selection to trigger the Trade Order. At 11.05, the Broker-Dealer API is called to obtain the Market Price of Listed Security.

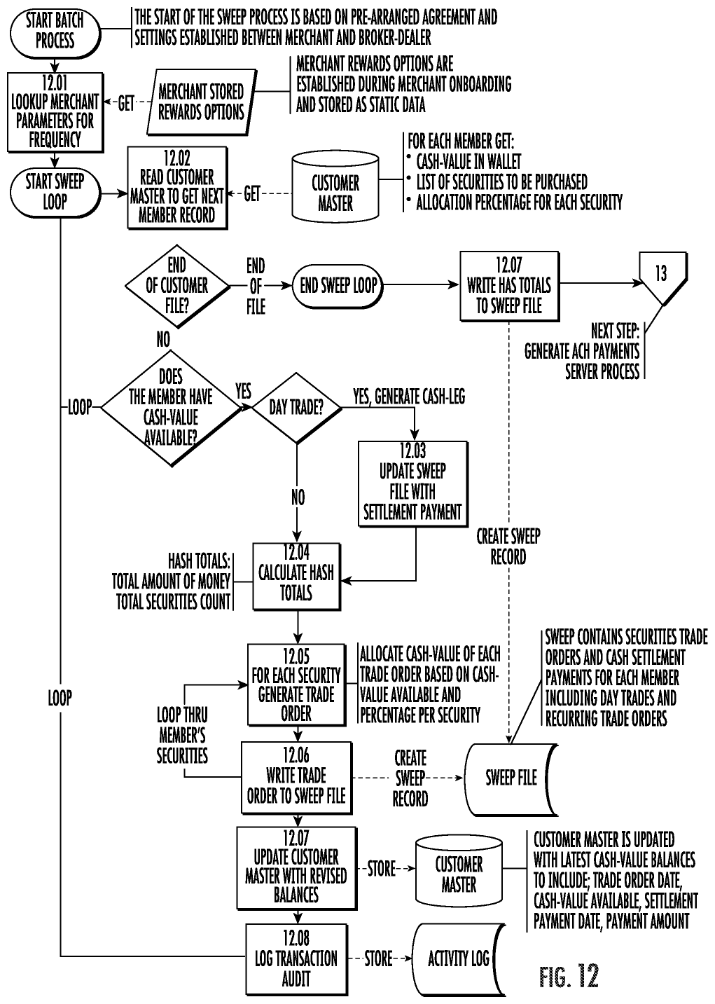

At 11.06, the Cash-Value Available in Wallet to Make Securities Purchase with Points is obtained. Cash-Value amount used in Day Trade/Single Orders will be swept during EoD Sweep Process and added to ACH payment to Broker. (See FIG. 12, Recurring Sweep Process)

At 11.07, the Listed Security with Market Price and Dollar Amount Available is displayed. The member then confirms the trade order at 11.08. This instructs system to enter a pending trade buy order that will be processed based on the Merchant's trade cycle.

At 11.09, the Market Order is prepared to be sent the Broker. Market Orders are submitted with cash-value, not shares, final Trade Order will be based on Cash-Value and Market Prices of securities at time of execution by Broker-Dealer where fractional share amount will be calculated. This may include whole and fractional shares based on cash-value available.

At 11.10, the Audit Log is updated with Outbound Transaction Info. The system maintains an activity log of all critical transactions and actions taken by Member. Then the wallet is updated at 11.11, with New Balances on the Customer Master. A call is made at 11.12 to the Broker-Dealer API Get Market Price of Listed Security. Then the order is submitted at 11.13, to the Broker-Dealer who returns Status Code of transaction. Members can cancel the conversion of Rewards points to stock before the trade order is placed and before the sweep process runs. After that, they will have to manage their positions using the Broker app/services that reside on Broker's platform. All trade orders generated and executed through the system will be ‘Market Orders’, which are ‘as-of’ the trade date which is driven by the Merchant Program policy (e.g., last business day of the month, 15th of the month, quarter-end, end of week, etc.) However, the Member, who will have a brokerage account at the Broker, will be able to manage their portfolio using full brokerage services provided by Broker on the Broker platform.

Buy Order: Unless otherwise noted, the user must have sufficient cash to cover the amount requested plus commission (if applicable). Market orders that are pending release to the market on next open cannot be cancelled after a certain time related to the opening time of that market, such as for example 9:28 am ET in the US.

If a user is submitting a notional based order, the amount after execution will never be more than what the user has requested but can be slightly less due to fractional rounding and price of the stock.

The audit log is then preferably updated at 11.14 with Inbound Transaction Info. The system maintains an activity log of all critical transactions and actions taken by Customer, Broker and Broker-Dealer to track and log a sequence of system events to provide supporting compliance documentation and audit trail including entries made by the Customer, messages sent between the platform and Broker-Dealer, return codes to evidence completion of trading activities, and acknowledgement of system requests, and results/completion of system requests. Further update may be made at 11.15, such that if the Return Code from the Broker-Dealer is a trade order request is good, where the acknowledgement is recorded on Activity log file.

Optionally at 11.16, an Error Message is displayed. If the Return Code from the Broker-Dealer is an error message or Trade Order rejected return the Member to Wallet Page for reentry. Optionally at 11.17, a message is displayed that an option not available if prohibited by Merchant program policy.

FIG. 12 shows a non-limiting, exemplary flow for updating wallet information.

At 12.01, Merchant parameters for Frequency are preferably obtained. The default option is that this server process will run on a recurring basis for a Merchant and all their underlying Members. It will calculate the total dollar amount accumulated for the monthly batch run, while preparing the individual pending trade orders requests that will be passed at the end of the period to the Broker/Broker-Dealer for execution.

This module represents one of the key components of the stock-backed loyalty program, which will operate under the recurring cash sweep options and parameters as established by between the Merchant and Broker. The start of the Sweep Process is based upon pre-arranged agreement and settings established between Merchant and Broker-Dealer. This module will automatically execute a sweep of cash balances that are made available by each Member election to generate individual trade orders that will be passed to the Broker for execution on a specific date.

At 12.02, the Sweep Loop starts, by reading the Customer Master to Get Next Member Record from Customer Master. For each Member get: Cash-Value in Wallet, List of Securities to be Purchased, Allocation Percentage for Each Security. When the end of the Customer Master is reached for the range of Members in the active Merchant (in a multi-tenant environment) write hash total and end this process and start Generate ACH Server process (FIG. 13) to create ACH payment and Tracer files.

At 12.03, the Sweep File is updated with Settlement Payment. The Sweep Process (i.e., Sweep Engine) will use the converted cash value to determine the amount available to buy securities on a periodic basis. The Sweep Engine will use the Member's election to split the cash-value amount to be allocated between various securities. The Sweep process will also check for any Day Trades conducted during the sweep period by individual Members to create the cash leg of the Day Trade required for account funding and settlement.

At 12.04, the Hash Totals are calculated, through any suitable method, in order to ensure the accuracy of the processed data. The Sweep Engine will also have to aggregate the total amount for the entire batch to calculate the ACH payment to be made by the Merchant to the Broker, along with splitting out necessary fees for Broker/Broker-Dealer.

At 12.05, for each Security, a Trade Order is generated. The Sweep Engine will generate Market Orders requests for each security with the cash amount for the Trade Order. Broker/Broker-Dealer will use this amount to calculate the number of shares to be purchased, including both whole and fractional amounts. The Cash-Value of each Trade Order based on Cash-Value Available and Percentage per Security is allocated.

Then the trade order is written at 12.06 to Sweep File. The Sweep Engine will also provide the Broker/Broker-Dealer with the total batch cash amount so they can set up a “receive” for the single ACH payment. Once the payment is received by the Broker/Broker-Dealer, the funds will be allocated to each brokerage account on behalf of the Member/Customer, and then the Trade Orders will be placed on the market. A Sweep Record is preferably created for individual trade orders—Sweep contains securities Trade Orders and Cash Settlement Payments for each Member including Day Trades and Recurring Trade Orders.

At 12.07, the Customer Master is updated with Revised Balances. Customer Master is updated with latest Cash-Value balances to include Trade Order Date, Cash-value available, Settlement Payment Date, Payment Amount. Then the Transaction Audit is logged at 12.08 to Activity Log file.

FIG. 13 shows a non-limiting exemplary flow for generating ACH and tracer files.

The loop begins at 13.01 by starting the ACH Loop and reading Sweep File. This process will read the Sweep File generated in the process server process (see FIG. 12, Recurring Sweep Server Process). The actual funds transfer will execute in the form of two ACH requests, one directly to the Broker, which will be processed through ACH gateways into the bank accounts of the Broker. After the Merchant receives the Payment Request from the system based on the period sweep process or individual trades, the Merchant will initiate the payment process. These payments have two legs the first is the individual allocations for each Member/Customer participating in the current cycle along with the aggregated (single) payment being made to the Broker prior to trade execution. Broker will use accompanying “Tracer File” to allocate funds to individual brokerage accounts before release of Trade Orders.

If the end of the Sweep file is reached end the ACH loop and go to Create ACH Payment Files.

At 13.02, fees Charged to Broker and Merchant are calculated. Merchant and Broker fees are prearranged as part of Service Agreement and stored as static data. Fees are based on Trade Orders volume/count, New Account Openings, and other activities. As part of the monthly process the system will calculate associated fees and subscription charges along with the actual trade blotter and settlement payments.

The fees may be split between multiple parties, namely the Broker, and potentially others such as Introducing Brokers (IB) and Registered Investment Advisors (RIA). In all cases, there would be separate ACH payments for each party. This is a service/surcharge fee for the conversion of points and generation of trade orders. Broker may also charge a trade/market fee based on agreements between Merchant and Broker. Based on this, the tracer file will include associated fees and ACH payments to be made between parties.

At 13.03, Tracer File Records are created. Tracer File provides Merchant and Broker with details of the generated trade orders, cash-value/points drawn down from Member's balances, Fees, and Gross Payments to fund brokerage accounts. The Tracer File will be transmitted to two parties: The Merchant and the Broker/Broker-Dealer. If other third-parties are involved with the transaction, they too will be included in the submission.

The ACH Payments Files are created at 13.04. At the end of the Sweep Process the system will generate the ACH batch payment requests. ACH Payments are based on the periodic sweep process and is calculated using individual trade orders and associated fees charged to Merchant and Broker. The system will submit the payment request to the Merchant, and through their internal Cash Management process, the Merchant will create the ACH file which will be saved and archived, but it will not be immediately transmitted. The Merchant must approve and transmit the file to the participant's bank.

Once the Broker/Broker-Dealer receives the ACH payment file, it allocates the appropriate amount to each Member Brokerage Account at Broker, which is maintained on the Broker's platform. The system provides a Tracer File to the Merchant and Broker/Broker-Dealer containing individual cash balances, the bulk amount to be paid, and fees associated with the transactions.

At 13.05, the ACH Payments are transmitted to Recipient Banks. The system starts a direct payment transaction using the ACH Network Gateway. ACH transactions can be either debit or credit, in this case a credit to the Broker's account from the Merchant's account. The Merchant's bank, also known as the originating depository financial institution (ODFI), takes the ACH transaction and batches it together with other ACH transactions to be sent out at regular times throughout the day.

An ACH operator, either the Federal Reserve or a clearinghouse, receives the batch of ACH transactions from the ODFI with the originator's transaction included. The ACH operator sorts the batch and makes transactions available to the bank or financial institution of the intended recipient (i.e., Broker), also known as the receiving depository financial institution (RDFI). The recipient's bank account receives the transaction, thus reconciling both accounts and ending the process. The payments associated to trade orders go straight to the Broker—corresponding transaction fees go directly to Broker-Dealer.

Tracer Files to Broker and Merchant are transmitted at 13.06. The system will retain and archive each Tracer File for historical and reconciliation purposes. Tracer File provides Merchant and Broker/Broker-Dealer with details of the generated trade orders, cash-value/points drawn from Member's balances, Fees, and Gross Payments to fund brokerage accounts sent via SFTP.

API Trade Orders process is performed at 13.07. This API supports access to general brokerage transactions in the form of trade buy and sell order requests, and updates or cancels to pending orders. Whether through a single instruction to place a trade order (i.e., Single Order Day Trade, FIG. 11, Invest Now—Single Order Page) or through the batch process triggered by the batch Sweep process, this module will execute Trades Orders when the ACH payment from the Merchant's bank hits the Broker's account. Once payment received and acknowledged, the Broker will automatically allocate the funds to each Member account at the Broker, and then place the “Market Orders” on the scheduled trade date. The funds will be used to settle the trade on trade date plus two days, or based other product schedule periods, such as Mutual Funds settle next day.

At 13.08, the Transmission History is written to Log File to Activity Log file.

FIG. 14 shows an exemplary, non-limiting system for supporting share purchases with loyalty program points according to at least some embodiments of the present invention. As shown in a system 1400, there is provided a user computational device 1402 in communication with the server gateway 1412 through a computer network 1410 such as the internet for example.

User computational device 1402 includes the user input device 1406, the user app interface 1404, and user display device 1408. The user input device 1406 may optionally be any type of suitable input device including but not limited to a keyboard, microphone, mouse, or other pointing device and the like. Preferably user input device 1406 includes a microphone, a keyboard, mouse, or keyboard mouse combination. User display device 1408 is able to display information to the user for example from user app interface 1404. The user operates user app interface 1404 for performing trades and viewing reward points, for example through a transaction engine 1416 being operated by server gateway 1412. This information is taken in from user app interface 1404 through the server app interface 1414. The information analyzed by transaction engine in 1416 preferably relates to a combination of trading information, points through a reward program and also any restrictions that may be placed on trade.

User computational device 1402 also comprises a processor 1405A and a memory 1407A. Functions of processor 1405A preferably relate to those performed by any suitable computational processor, which generally refers to a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory, such as a memory 1407A in this non-limiting example. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Also optionally, memory 1407A is configured for storing a defined native instruction set of codes. Processor 1405A is configured to perform a defined set of basic operations in response to receiving a corresponding basic instruction selected from the defined native instruction set of codes stored in memory 1407A. For example and without limitation, memory 1407A may store a first set of machine codes selected from the native instruction set for receiving information from the user through user app interface 1404 and a second set of machine codes selected from the native instruction set for transmitting such information to server 1412, for example in relation to transaction orders.

Similarly, server 1412 preferably comprises a processor 1405B and a memory 1407B with related or at least similar functions, including without limitation functions of server 1412 as described herein. For example and without limitation, memory 1407B may store a first set of machine codes selected from the native instruction set for receiving a loyalty point transactional command from user computational device 1402, and a second set of machine codes selected from the native instruction set for executing functions of transaction engine 1416.

Preferably orders are placed through a broker computational device, which communicates with server 1412 (not shown). Preferably restrictions on and requirements for such orders are determined through a merchant computational device 1418, which communicates with server 1412 through a merchant interface 1422.

For example, customers can elect to redeem shares from their various loyalty programs through the discrete wallet app for cash to be cleared from the account or invested in other financial offerings made available by the Broker and facilitated by the operations of server 1412. User app interface 1404 may support such a wallet app as described herein.

Server 1412 preferably has multi-tenant capabilities which will support numerous Merchants and their individual programs, while maintaining separation between each unique Merchant program. Server 1412 preferably supports the ability to combine an individual customer's points, cash available, and brokerage services to a single Wallet and behind it a consolidated-brokerage account, or support services across multiple brokerage accounts.

Server 1412 also supports various Application Services. The application services provide rewards and loyalty program managers (i.e., Merchants) with a link to convert loyalty points earned by the customer into securities investments. This is accomplished through integrating existing loyalty/rewards platforms with technical services, and through those services, to backend brokerage, compliance, and custody/clearing facilities.

There are three primary components to the end-to-end process, starting with the Merchant loyalty program that plugs into stock-backed wallet, followed by the core services provided by through a series of mobile, web and server-side applications, which then connect to backend brokerage, compliance, clearing, custodial service stack.

The conversion process requires roundtrip capabilities where services are initially invoked from the Merchant's web/mobile application while making calls to server-side applications through APIs to perform frontend functions. To continue the operation, those requests are preferably performed with server-side apps at server 1412 and post JSON in return while connecting to the broker/broker-dealer to execute authentication, customer onboarding, compliance and trading related events.

Server 1412 may then connect to broker-dealer's backend services via REST APIs using only server-to-server protocols with a corresponding session key (token). On most processes, will receive status and content back from the broker/broker-dealer after fulfillment of each service event.

At its core, the technical platform provided through transaction engine 1416 facilitates direct linking of point conversion from a single Merchant Loyalty Program to shares in the same Merchant's stock by introducing trade flow to the Broker at the backend. Preferably, server 1412 supports provision of the following services through user app interface 1404:
Provide Members with a series of informative pages describing how the Merchant stock-backed program works where a Member can swipe through a series of screens to learn more about the overall stock-backed rewards offering and related promotions
Present Merchant offerings option (i.e., list of securities, products, funds, ETFs, baskets of stocks, etc.) to which they can redeem points in exchange for investments to include whole and fractional shares
Allow Member to select securities-backed option using a portion (i.e., percentage of points available or actual dollar amount) of earned loyalty points sitting in Wallet
Manage Member elections to either make one-time or recurring elections for the use of points available to purchase securities
Manage Member selection of single loyalty-stock (i.e. Merchant stock only), self-directed, or registered investment advisor (RIA), or algorithmic advisor service (e.g., Robo Advisor)
Provide the ability to view pending and completed transactions and cash balances held in Wallet
Link (bi-directionally) Merchant stock-backed loyalty and rewards programs with backend brokerage and clearing services
Offer a simple one-way redemption of points to purchase shares, or a two-way capability to exchange shares back to points, based on permissions within the Merchant's program options
Place securities (trade purchase) order requests to be electronically submitted to Broker, under one of two scenarios:
Process a simple baseline feature to exchange points for the Company's (Merchant's) stock only, or
Purchase of securities based on a list of investments as determined by the Merchant's predefined program options, including Merchant's shares, listed securities available for self-directed trading, Electronically Traded Funds (ETF), or managed through Broker/RIA
Automate recurring (e.g. monthly, weekly) transactions according to rules (Merchant parameters) defined by the Merchant Loyalty Program, that automatically sweeps points acquired during the last points period in order to buy additional shares of Merchant's stock, or other securities based on Member's elections
Provide unrestricted access for Members to all their investments available through brokerage portal for self-directed accounts
Provide the ability to view confirmations and statements related to brokerage transactions, balances, and holdings
Provide the ability to request the transfer of loyalty points from other Rewards Programs to be collected and centralized in the Wallet for future stock purchase trade orders

The features outlined below will be made available through APIs operated by server 1412 that link to backend brokerage services using REST API, with the ability to:
Display stock-backed rewards program promotions/offerings
Allow Member to make elections for the use of points
Allow Member to make elections for one-time trade order or recurring trade orders based on cash value available
Filter and display available securities based on predetermined Merchant program options allowing Members to select securities investments
Place “Buy” (and sell in later phase) trade orders for securities based on Member's elections
Source Members' personal account information from the Merchant through an API, when available from the Merchant
Auto-populate the Member account open (KYC/Due Diligence) form, sourcing data provided by Merchant, this information is then updated and confirmed by Member on their mobile device or via website
Request the opening of a new Member account on the Broker platform
Display Member Wallet with points available, cash value equivalent available, and portfolio holdings
Display Member trade confirmations and portfolio statements on request
Send email alerts, notifications, account events, confirmations, statements, and compliance alerts to Members that are part of the normal business cycle and compliance related events
Access Members' Brokerage accounts directly through Broker portal
Calculate fees and charges associated with each transaction type (i.e., subscription fees, account opening/setup and onboarding, trade execution fees, and splits between and Broker)
Process Merchant's fee and settlement payments with and Broker though Automated Clearing House (ACH) payment transactions
Auto-generate trade orders based on Member's Wallet cash-value available balance and elections made by the Member in line with Merchant program parameters

FIG. 15 shows an exemplary, non-limiting system, according to an illustrative implementation, for supporting share purchases with loyalty program points according to at least some embodiments of the present invention.

The core functions in this system preferably run on cloud services, with mobile and web components running or launching from within the Member's mobile device or Merchant's website. The application suite includes mobile, web and server-side applications, are as follows:
Stock-backed service offerings (i.e., general information and promotional pages)
Member elections of points used and stock selections (investments)
Member onboarding through KYC, due diligence, and OFAC/AML process
Wallet to display and manage; points held, cash balance, portfolio value, and pending and completed orders
Placing trade orders as one-time or recurring events
Processing of payments, deposits, and settlements
Calculation and management of fees and charges, including preparing information for invoicing purposes and automated ACH payments

1. System Architecture

The following sections and accompanying System Architecture and Process Flow diagrams provide a high-level overview of how the Middleware interacts with the Merchant and Broker technology platforms.

1.1. Frontend Modules (Mobile App and Website Application)

The System Architecture diagram above indicates the general process flow from the perspective of the Merchant frontend and Member experience from top to bottom as the normal sequence of events. These actions can occur in varying sequences based on the status and entry point of a Member. The “Merchant Frontend”, will consist of software that embeds within the Merchant applications and it will interact with modules outlined in the server application services section via REST APIs, or through components embedded in the mobile and web applications.

The primary events occurring on the Merchant Frontend, including mobile/web and server-side processes, are as follows:
Maintenance of Member Points Earned
Convert Points to Cash
Open Account and Confirm Profile
View Member Wallet
Convert and Invest Opt-in
View Member Portfolio

1.2. Middleware (Real-Time Application Services)

The “Middleware”, which will run on cloud services, or on-premises, offers API connections and internal server-side apps that perform key operational functions, including the ability to:
Maintain and present Merchant program options and parameters
Facilitate the opening of new accounts with proper due diligence
Perform maintenance and management of the Member Wallet
Process and convert one-time and recurring points sweep into trade order requests
Facilitate settlement and payment transactions
Calculate and distribute commercial fees and related charges
Generate and transmit a tracer file of Member pending orders with the amount to be allocated to individual brokerage accounts at the Broker
Summarize and transmit the accompanying ACH payments
Provide account management capabilities for individual Members
Access Merchant status dashboards and analytics through the “Partner Portal”

1.3. Technical Architecture Standards

Mobile App Standards

Mobile apps and components described in the document will run on the latest Apple iOS and Google Android operating systems with backward compatibility of two generations. Mobile components will comply with standard distribution policies and guidelines based on Apple's App Store Guidelines, and Google Play Developer Distribution Agreement.

Web Application Standards

Web applications will run on the latest versions with backward compatibility for at least two versions of the following web browsers: Chrome, Firefox, Internet Explorer, Microsoft Edge (replaces Internet Explorer in Windows 10) and Safari, accessed via HTTPS protocols.

Server Applications/Modules server-side application modules will be built using Kotlin Spring Microservices leveraging its modular, loosely-coupled service approach, which allow for segmented design, develop, test, and deploy them independently. They are also an ideal candidate for continuous delivery and deployment as we buildout the longer terms components.

RESTful API

Server-side software modules, applications, data access, and data queries will run on cloud-based services and follow standards outlined in at least one of the following cloud platform services, including Amazon Web Services (AWS) Cloud Computing Services, Google Cloud Services, or Microsoft Azure Cloud Services.

uses REST API and standard HTTP verbs to communicate and returns HTTP codes and JSON messages to indicate statuses and errors, and exchanges of data. All API requests must be made over HTTPS.

Database and Data Storage (MongoDB)

MongoDB is a highly scalable database and it will be used as the backend data store for platform where data is stored in MongoDB, providing fast and scalable data storage service to meet requirements of the performance-critical application.

1.4. Backend (Broker/Broker-Dealer)

Integration with the Broker backend functions will be performed though REST APIs using server-to-server methods.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for managing loyalty points from a merchant for a user, comprising a user computational device, a server, a merchant computational device and a computer network, wherein said user computational device, said server and said merchant computational device communicate through said computer network, wherein said user computational device comprises a user app interface, a memory for storing instructions and a processor for executing said instructions, wherein said memory stores a first set of machine codes selected from the native instruction set for receiving information from the user through said user app interface, a second set of machine codes selected from the native instruction set for transmitting said information to said server, wherein said information comprises a transaction order for transferring at least one loyalty point to a financial instrument; wherein said server comprises a transactional engine, said transactional engine operating according to at least one rule obtained from said merchant computational device, a server memory for storing instructions and a server processor for executing said instructions; wherein said server memory stores a first set of machine codes selected from the native instruction set for receiving a loyalty point transaction command from said user computational device, and a second set of machine codes selected from the native instruction set for executing functions of said transaction engine to cause said at least one loyalty point is transferred to said financial instrument according to said transaction order.

2. The system of claim 1, wherein said financial instrument comprises a share, wherein said merchant is associated with a publicly traded company and wherein said share is of said associated publicly traded company.

3. The system of claim 1, wherein said financial instrument comprises a share, wherein said share is of a publicly traded company other than said merchant or a company associated with said merchant, and wherein said share is of said other publicly traded company.

4. The system of claim 3, further comprising a broker computational device, wherein said broker computational device is in communication with said server through said computer network, wherein said share is obtained through a command sent from said server to said broker computational device.

5. The system of claim 4, wherein a rule for determining a financial instrument that is selectable according to said transaction order is set according to a command from said merchant computational device to said server.

6. The system of claim 5, wherein a rule for determining an amount of loyalty points that are exchangeable for said financial instrument is set according to a command from said merchant computational device to said server.
